(19) United States
(12) Patent Application Publication
(10) Pub. No.: US 2015/0371839 A1
(43) Pub. Date: Dec. 24, 2015

(54) ION TRANSPORT DEVICE AND MASS ANALYSIS DEVICE

(71) Applicant: SHIMADZU CORPORATION, Kyoto-shi (JP)

(72) Inventor: Motohide YASUNO, Kyoto-shi (JP)

(73) Assignee: SHIMADZU CORPORATION, Kyoto-shi (JP)

(21) Appl. No.: 14/645,850

(22) Filed: Mar. 12, 2015

(30) Foreign Application Priority Data
Jun. 24, 2014 (JP) 2014-128816

(51) Int. Cl. H01J 49/06; H01J 49/42

(52) U.S. Cl. CPC H01J 49/066; H01J 49/4255

(57) ABSTRACT

A first ion transport unit with an ion funnel structure having high acceptance is arranged in the front half and a second ion transport unit with a Q-array structure having low emittance and high gas conductance is arranged in the rear half, and an aperture electrode to which only direct current voltage is applied is provided between them. The inside diameter of the opening of the aperture electrode is made larger than the inside diameter of the opening of the ring electrode at the last stage of the first ion transport unit, and the inscribed circle diameter of the first stage electrode plate of the second ion transport unit is made larger still. As a result, interference of high frequency electric fields between the first ion transport unit and the second ion transport unit 14 is reduced and ions which have exited the first ion transport unit are inputted at low loss into the second ion transport unit.

### TECHNICAL FIELD

The present invention relates to an ion transport device for transporting ions from a region with a relatively high gas pressure to a region with a relatively low gas pressure, as well as a mass analysis device using such an ion transport device.

### BACKGROUND ART

In atmospheric pressure ionization mass analysis devices and DART (Direct Analysis in Real Time) ionization mass analysis devices used in liquid chromatography-mass spectrometry (LC-MS) systems, sample components are ionized in an ionization unit with a substantially ambient pressure atmosphere. The generated ions are then fed into an analysis chamber which is maintained at a high vacuum atmosphere, and are detected after being separated according to the mass-to-charge ratio m/z by a mass separator such as quadrupole mass filter arranged inside the analysis chamber. In order to perform high sensitivity analysis in such a device, it is necessary to transport the ions generated in the ionization unit to the analysis chamber at a low loss, and to that end, it is important to increase the ion transport efficiency in the ion transport optical system installed in one or multiple intermediate vacuum chambers making up a multistage differential exhaust system, which are provided between the substantially ambient pressure ionization unit and the high vacuum analysis chamber.

In particular, the first intermediate vacuum chamber at the next stage after the ionization unit has a low degree of vacuum due to the influence of ambient air which flows in from the preceding stage. Thus, in order to achieve a high ion transport efficiency in the ion transport optical system provided inside the first intermediate vacuum chamber, it is essential to reduce the loss of ions due to collision of ions with gas during transport as much as possible. As this sort of an ion transport optical system for transporting ions under relatively high gas pressure, an ion funnel, multipole ion guide and the like is commonly used, which transport ions whereof the kinetic energy has been attenuated by collision with gas (i.e. collisionally cooled ions) while focusing the ions with a high frequency electric field.

An ion funnel has an electrode structure in which multiple ring electrodes, having a circular opening whereof the opening diameter decreases gradually in the ion transport direction, are arrayed at equal intervals along the ion optical axis (see patent documents 1 and 2). In an ion funnel, high frequency voltages of inverted phase are applied to any two-ring electrodes adjacent in the ion transport direction, thereby forming a high frequency electric field which focuses ions in the truncated cone shaped space surrounded by the ring electrodes. Furthermore, a direct current voltage which changes in stepwise fashion is applied to each of the ring electrodes arrayed in the ion transport direction, thereby forming a direct current potential gradient which promotes the travel of ions (i.e. accelerates the ions) in the aforementioned space surrounded by the ring electrodes.

Moreover, a multipole ion guide has an electrode structure in which an even number (usually, 4 or 8) of rod electrodes extending in the ion transport direction are arranged in parallel to each other at equiangular intervals about the ion optical axis. In a multipole ion guide, high frequency voltages of inverted phase are applied to any two-rod electrodes adjacent in the circumferential direction about the ion optical axis, thereby forming a high frequency electric field which focuses ions in the space surrounded by the rod electrodes. In a multipole ion guide with a typical configuration in which the rod electrodes are arranged in parallel to the ion optical axis, a direct current potential gradient in the ion transport direction is not formed, but it is known that a direct current potential gradient in the ion transport direction can be formed through modifications such as arranging the rod electrodes at a diagonal tilt to the ion optical axis.

Furthermore, an ion guide called a Q-array, as described in patent document 3, etc., is known as an ion transport optical system which improves upon a multipole ion guide. In a Q-array, a single rod electrode of a quadrupole ion guide is replaced with a virtual rod electrode comprising multiple electrode plates arrayed in the direction in which the rod electrodes extend. Just as in a quadrupole ion guide, among the four virtual rod electrodes, high frequency voltages of inverted phase are applied to any two virtual rod electrodes adjacent in the circumferential direction about the ion optical axis. Furthermore, since a virtual rod electrode comprises multiple electrode plates, it is also possible to apply different direct current voltages to the electrode plates arrayed in the ion transport direction and form a direct current potential gradient in the ion transport direction.

### PRIOR ART DOCUMENTS

### Patent Documents

[Patent document 1] Specification of U.S. Pat. No. 6,107,628
[Patent document 2] Specification of U.S. Pat. No. 6,583,408
[Patent document 3] International Publication No. 2008/129751

### Non-Patent Documents

[Non-patent document 1] Dieter Gerlich, “INHOMOGENEOUS RF FIELD: A VERSATILE TOOL FOR THE STUDY OF PROCESSES WITH SLOW IONS” [retrieved Mar. 10, 2014], Internet <URL: http://www.tu-chemnitz.de/physik/ION/Publications/ger92.pdf>

### SUMMARY OF THE INVENTION

### Problem to be Solved by the Invention

As described above, ion transport optical systems of various configurations intended for efficiently transporting ions under a relatively high gas pressure (low degree of vacuum) have been proposed and put into practical use in the prior art. Meanwhile, in recent years, there has been increasing demand for high sensitivity in mass analysis devices, and thus, further improvements of ion transport efficiency have been sought also for the ion transport optical system. In relation to such demands, there is a limit to the improvements in performance through simply optimizing the structural parameters such as the size of the components or the control parameters such as the applied voltage level in conventional ion funnels, multipole ion guide, Q-arrays and the like.

Furthermore, in a mass analysis device with a multistage differential exhaust system configuration, the introduction of ions from the ionization unit to the first intermediate vacuum chamber is accomplished through an ion introduction unit such as a small diameter pipe or a small opening formed in the vertex of a sampling cone, but in order to feed ions generated in the ionization unit with as little waste as possible into the first intermediate vacuum chamber, it is desirable for the area of the ion transit opening in the ion introduction unit to be made larger. However, if this is done, the amount of gas introduced from the ionization unit into the first intermediate vacuum chamber through the ion introduction unit will also increase. Here, if the gas conductance is low between the region in the ion transport optical system through which ions transit (in the case of an ion funnel, the region formed by the circular openings of the plurality of ring electrodes) and the region on the outside of the ion transport optical system (in the case of an ion funnel, the region on the outside of the plurality of ring electrodes), there is a concern that this will lead to problems such as an increase in the gas flowing into the second intermediate vacuum chamber, which is the next stage after the first intermediate vacuum chamber, and an increase in the load on the vacuum pump which evacuates the second intermediate vacuum chamber. Thus, it is especially preferable for the ion transport optical system installed in the first intermediate vacuum chamber to have as high a gas conductance as possible between the ion transit region and the outside region while maintaining high ion transport efficiency.

The present invention was made in view of this point, its object being to provide an ion transport device capable of achieving higher ion transport efficiency under a low vacuum atmosphere as compared to existing ion transport optical systems, and to provide a mass analysis device using said ion transport device.

Another object of the present invention is to provide an ion transport device capable of increasing gas conductance between the region through which ions transit and the outside region while achieving high ion transport efficiency, and to provide a mass analysis device using said ion transport device.

### Means for Solving the Problem

In order to increase the ion transport efficiency in an ion transport device, as described above, it is important not only to reduce the loss of ions during ion transport by the device, but to also have a high acceptance (ion acceptance) for ions arriving from the preceding stage and a low emittance (ion spatial spread in the radial direction) of ions being sent to the subsequent stage. This ion acceptance characteristic and ion emittance characteristic depend on the radial pseudopotential distribution in the space through which the ions transit.

This will be discussed in detail later, but if an ion funnel is compared to a multipole ion guide, due to differences in the shape of the radial pseudopotential distribution, an ion funnel is superior in terms of ion acceptance characteristic but inferior in terms of ion emittance characteristic, while a multipole ion guide is conversely superior in terms of ion emittance characteristic but inferior in terms of ion acceptance characteristic. The pseudopotential distribution of a Q-array is about the same as that of a quadrupole ion guide, so its ion acceptance characteristic and ion emittance characteristic can be considered to be about the same as those of a quadrupole ion guide. However, a Q-array allows the ion acceptance characteristic and ion emittance characteristic to be adjusted by adjusting the inscribed circle diameter of the electrode plates, the gap between the electrode plates, etc.

Furthermore, in an ion funnel, the shape of the radial pseudopotential distribution is well-shaped (U-shaped) and the potential gradient is steep, so the confining force on ions is strong, making the ion funnel well suited for ion transport in a low vacuum atmosphere where the frequency of collisions between ions and gas is high. On the other hand, an ion funnel has low gas conductance between the ion transit region and the outside region and gas which has been introduced into the ion transit region cannot escape readily to the outside, so a state of high gas pressure can readily develop near the outlet of the ion funnel as well. By contrast, in a Q-array, gaps are present both between adjacent electrode plates in the circumferential direction and adjacent electrode plates in the ion optical axis direction, so the gas conductance between the ion transit region and the outside region is higher compared to both ion funnels and multipole ion guides. Thus, gas which has been introduced into the ion transit region can readily escape to the outside of the electrode plates and a state of high gas pressure does not develop readily near the outlet of the Q-array.

As a reasonable configuration which takes into account the various parameters, such as ion acceptance and ion emittance, appropriate degree of vacuum for ion transport operation and gas conductance, involved in an ion transport optical system which operates under a low vacuum atmosphere as described above, the present inventor conceived of a hybrid configuration wherein a first ion transport unit corresponding to an ion funnel is arranged on the inlet side from which ions enter, being fed together with gas from a first region of relative high gas pressure, and wherein a second ion transport unit corresponding to a Q-array is arranged on the outlet side from which ions are fed to a second region of relatively low gas pressure. However, since the potential distribution of the high frequency electrode field formed in the space surrounded by the electrodes (i.e. the ion transit region) differs between the first ion transport unit and the second ion transport unit, it is possible that disturbances of the high frequency electric field will occur at the boundary between the first ion transport unit and the second ion transport unit, making the behavior of the ions unstable. Thus, an aperture electrode to which only direct current voltage is applied was provided at the boundary between the first ion transport unit and the second ion transport unit, so as to reduce the mutual interference of the high frequency electric fields of the front half unit and rear half unit sandwiching the aperture electrode.

Namely, a first aspect of the ion transport device according to the present invention, made to resolve the problem described above, is an ion transport device which is arranged, for the purpose of transporting ions from a first region with a relatively high gas pressure atmosphere to a second region with a relatively low gas pressure atmosphere, in a third region with an atmosphere with gas pressure between that of those two regions, the ion transport device being characterized in that it comprises:

a) a first ion transport unit which is arranged on the inlet side from which ions fed from said first region enter, comprises multiple ring electrodes arrayed along the ion optical axis, and has a funnel structure wherein the inside diameter of the opening of the ring electrodes on the inlet side is greater than the inside diameter of the opening of the ring electrodes on the outlet side;

b) a second ion transport unit which is arranged after said first ion transport unit, and wherein an even number of four or more virtual rod electrodes, comprising a plurality of electrode plates arrayed along the ion optical axis, are arranged about the ion optical axis, and the inscribed circle of the electrode plates contained within each of the virtual rod electrodes within the plane orthogonal to the ion optical axis decreases gradually from the inlet side to the outlet side;

c) an aperture electrode which is arranged between said first ion transport unit and said second ion transport unit and has an opening in the center through which ions transit; and

d) a voltage generating unit which applies a voltage comprising a superimposed high frequency voltage and direct current voltage to the ring electrodes contained in said first ion transport unit and to the electrode plates contained in said second ion transport unit, and applies a direct current voltage to said aperture electrode.

Furthermore, a second aspect of the ion transport device according to the present invention, made to resolve the problem described above, is an ion transport device which is arranged, for the purpose of transporting ions from a first region with a relatively high gas pressure atmosphere to a second region with a relatively low gas pressure atmosphere, in a third region with an atmosphere with gas pressure between that of those two regions, the ion transport device being characterized in that it comprises:

a) a first ion transport unit which is arranged on the inlet side from which ions fed from said first region enter, comprises multiple ring electrodes arrayed along the ion optical axis, and has a funnel structure wherein the inside diameter of the opening of the ring electrodes on the inlet side is greater than the inside diameter of the opening of the ring electrodes on the outlet side;

b) a second ion transport unit which is arranged after said first ion transport unit, and wherein an even number of four or more virtual rod electrodes, comprising a plurality of electrode plates arrayed along the ion optical axis, are arranged about the ion optical axis, and the gap between adjacent electrode plates in the ion optical axis direction in each of the virtual rod electrodes decreases gradually from the inlet side to the outlet side;

c) an aperture electrode which is arranged between said first ion transport unit and said second ion transport unit and has an opening in the center through which ions transit; and

d) a voltage generating unit which applies a voltage comprising a superimposed high frequency voltage and direct current voltage to the ring electrodes contained in said first ion transport unit and to the electrode plates contained in said second ion transport unit, and applies a direct current voltage to said aperture electrode.

In both the first and second aspects of the ion transport device according to the present invention, a first ion transport unit corresponding to an ion funnel is arranged on the inlet side, i.e. as the front half unit, and a second ion transport unit corresponding to a Q-array is arranged on the outlet side, i.e. as the rear half unit, so as to sandwich an aperture electrode to which only direct current voltage is applied.

The first ion transport unit having an ion funnel structure comprising multiple ring electrodes has a high ion acceptance, so it efficiently accepts spatially spread ions which are fed together with a gas stream from the first region. Furthermore, the first ion transport unit has relatively low gas conductance, so the gas pressure in the space surrounded by the ring electrodes of the first ion transport unit is higher than in the surrounding area (the gas pressure of the third region). As a result, excess energy possessed by the ions is attenuated by a high collisional cooling effect, and the ions become easier to capture in the high frequency electric field. Furthermore, in this first ion transport unit, since the confinement force on ions based on the high frequency electric field is strong, ions can be transported at low loss even under a low vacuum atmosphere.

Ions focused by the action of the high frequency electric field in this manner transit through the opening in the aperture electrode and are introduced into the second ion transport unit. The high frequency electric field is discontinuous between the first ion transport unit and the second ion transport unit, but since an aperture electrode to which only direct current voltage is applied is provided between the two, the high frequency electric fields near the rear end of the first ion transport unit and near the front end of the second ion transport unit are not readily affected by each other. Thus, major disturbances in the high frequency electric field at the boundary between the two can be eliminated, and ions can smoothly transit across this boundary.

Ions which have been introduced into the second ion transport unit are transported while being focused by a multipole electric field. The second ion transport unit is formed so that, as the ions travel forward, the inscribed circle of the electrode plates contained in each virtual rod electrode in the plane orthogonal to the ion optical axis becomes smaller, or the gap between adjacent electrode plates in the ion optical axis direction becomes narrower. Of course, both of these can be the case as well. As the inscribed circle radius of the electrode plates becomes smaller, the width of the bottom of the pseudopotential generated by the high frequency electric field becomes narrower. Furthermore, as the distance between electrode plates becomes narrower, the effect of low order components in the multipole electric field becomes stronger (see patent document 3). Thus, the focused ions are outputted from the outlet end of the second ion transport unit with a small emittance. As a result, the ions transit efficiently through the orifice at the vertex of a skimmer or the like, and are fed from the third region to the second region.

In this way, in the ion transport device according to the present invention, ions are efficiently captured based on a high acceptance characteristic, the ions are transported at low loss while being focused, and are narrowed down to a small diameter and outputted with a low emittance characteristic. Thus, ion loss can be reduced at all stages from input to output, making it possible to achieve high ion transport efficiency.

Furthermore, a gas stream enters the central opening of the first ion transport unit together with ions from the first region, and since the gas conductance of the first ion transport unit is low, much of the gas stream flows further into the second ion transport unit, but the gas conductance of the second ion transport unit is high, so the gas rapidly disperses to the periphery of the ion transport unit, particularly through the circumferential gaps between the electrode plates. Thus, even when a large amount of gas is fed into the first ion transport unit, increase in gas pressure near the outlet of the second ion transport unit can be reduced, thereby making it possible to reduce the amount of gas which flows into the second region partitioned off by a skimmer or the like.

Furthermore, the ion transport device according to the present invention may be configured such that the inside diameter of the aperture electrode is made greater than the inside diameter of the opening of the ring electrode at the final stage of the first ion transport unit and less than the inscribed circle of the electrode plates of the first stage of the second ion transport unit.

Based on this configuration, ions which have come out of the outlet of the first ion transport unit, while being focused by the high frequency electric field, pass through the central opening of the aperture electrode without waste, and ions which have passed through the central opening of the aperture electrode can be inputted within the ion acceptance range of the second ion transport unit without waste. Furthermore, the high frequency fields formed respectively in the first ion transport unit and in the second ion transport unit are adequately shielded by the aperture electrode.

Furthermore, since the inside diameter of the opening of the ring electrode at the first stage of the first ion transport unit is large, the gas conductance to the front of the first ion transport unit is relatively high. Since collisional cooling effect is something one wants to make use of most at the inlet of the first ion transport unit, increasing the gas pressure in this area is advantageous for focusing of ions. Thus, in the ion transport device according to the present invention, preferably, a barrier structure, for reducing gas conductance between the space of the opening of the ring electrodes in the first ion transport unit and the space on the outside of the first ion transport unit, is provided in front of the first ion transport unit.

Based on this configuration, the gas pressure at the inlet of the first ion transport unit becomes higher compared to the case where there is no barrier structure as described above, so the collisional cooling effect becomes stronger and incoming ions can be captured more easily by the high frequency electric field.

The ion transport device according to the present invention is particularly useful for mass analysis devices in which there is a need to efficiently transport ions generated under ambient pressure to a region with a high vacuum atmosphere.

Namely, the distinguishing features of the ion transport device of the present invention can be especially made use of when the ion transport device of the present invention is installed in the intermediate vacuum chamber at the next stage after the ionization unit of a mass analysis device comprising an ionization unit which ionizes a sample under an ambient pressure atmosphere; an analysis chamber which is maintained at a high vacuum atmosphere and in which a mass separation unit is provided; and one or multiple intermediate vacuum chambers which are arranged between said ionization unit and said analysis chamber, and wherein the degree of vacuum increases in stepwise fashion.

### Effect of the Invention

With the ion transport device according to the present invention, particularly under conditions of relatively high gas pressure (low degree of vacuum), as, for example, in the intermediate vacuum chamber at the next stage after the ionization unit in an atmospheric pressure ionization mass analysis device, it is possible to achieve a higher ion transport efficiency as compared to existing ion transport optical systems such as ion funnels and multipole ion guides. Thus, a mass analysis device using the ion transport device according to the present invention can achieve higher detection sensitivity than in the prior art.

Furthermore, with the ion transport device according to the present invention, compared to an ion funnel, the gas pressure near the outlet through which ions are outputted from the ion transport device can be kept lower, making it possible to reduce the leakage of gas into the intermediate vacuum chamber or analysis chamber at the next stage after the intermediate vacuum chamber in which the ion transport device is installed. Thus, the load on the vacuum pump which evacuates that intermediate vacuum chamber or analysis chamber can be reduced, allowing one, for example, to achieve a cost reduction by using a low performance vacuum pump.

### BRIEF DESCRIPTION OF THE DRAWINGS

FIG. 1 A schematic diagram (a) and cross-sectional views of parts along view lines (b) through (e) of an ion guide arranged inside a first intermediate vacuum chamber in an embodiment example of an atmospheric pressure ionization mass analysis device using an ion transport device according to the present invention.

FIG. 2 A simplified diagram of the ion guide shown in FIG. 1 and the electrical circuit for applying voltage thereto.

FIG. 3 An overall diagram of the atmospheric pressure ionization mass analysis device of the present embodiment example.

FIG. 4 A drawing illustrating an example of the computation results for pseudopotential distribution of an ion transport optical system comprising ring electrodes and an ion transport optical system based on a multipole ion guide.

### DETAILED DESCRIPTION OF THE EXEMPLARY EMBODIMENTS

An embodiment example of an ion transport device according to the present invention and a mass analysis device using said ion transport device will be described with reference to the appended drawings.

FIG. 3 is a schematic diagram of the atmospheric pressure ionization mass analysis device of the present embodiment example. The configuration and general operation of the atmospheric pressure ionization mass analysis device of the present embodiment example will be described using FIG. 3.

This mass analysis device is provided with a first and second evacuated intermediate vacuum chambers 2 and 3 between an ionization chamber 1 which has a substantially ambient atmosphere and an analysis chamber 4 maintained at a high vacuum atmosphere by means of an unillustrated high performance vacuum pump such as a turbomolecular pump, and has a multistage differential exhaust configuration in which the degree of vacuum becomes higher (gas pressure becomes lower) in stepwise fashion going from the ionization chamber 1 to the analysis chamber 4. Normally, the gas pressure within the first intermediate vacuum chamber 2 is about 10 to 100 [Pa], the gas pressure in the second intermediate vacuum chamber 3 is about 0.1 to 1 [Pa], and the gas pressure in the analysis chamber 4 is about 10⁻³ to 10⁻⁴ [Pa].

The ionization chamber 1 and first intermediate vacuum chamber 2 communicate via a desolventizing tube 6, which is a pipe of small diameter, and the first intermediate vacuum chamber 2 and second intermediate vacuum chamber 3 communicate via a small diameter orifice 7a formed in the vertex of a skimmer 7. An ESI probe 5 for performing electrospray ionization (ESI) is provided in the ionization chamber 1, an ion guide 11 with a distinctive configuration, described later, is provided in the first intermediate vacuum chamber 2, an existing octapole ion guide 8 is provided in the second intermediate vacuum chamber 3, and a quadrupole mass filter 9 and ion detector 10 are provided in the analysis chamber 4.

When a sample solution containing sample components separated, for example, in the column of an unillustrated liquid chromatograph, is introduced into the ESI probe 5, the sample liquid is atomized inside the ionization chamber 1 while being imparted with a biased charged at the tip of the ESI probe 5. The sample components are ionized in the process of vaporization of the solvent in the atomized microdrops. The ions generated are picked up by the gas stream which flows to the desolventizing tube 6 due to gas pressure difference between the two ends of the desolventizing tube 6, and are introduced into the first intermediate vacuum chamber 2 after passing through the desolventizing tube 6. The ions are efficiently collected by the ion guide 11, described later, and are fed into the second intermediate vacuum chamber 3 through the orifice 7a. In the second intermediate vacuum chamber 3, the ions are focused by the octapole ion guide 8 and fed into the analytical chamber 4. In the analysis chamber 4, ions are introduced into the space along the long axis of the quadrupole mass filter 9, and only ions having a specified mass-to-charge ratio m/z pass selectively through the quadrupole mass filter 9 and arrive at and are detected by the ion detector 10.

The mass-to-charge ratio of ions which can pass through the quadrupole mass filter 9 differs according to the high frequency voltage and direct current voltage applied to the rod electrodes of the quadrupole mass filter 9. Thus, by scanning the high frequency voltage and direct current voltage applied to the rod electrodes of the quadrupole mass filter 9 while maintaining a predetermined relationship, it is possible to obtain an intensity signal for ions across a predetermined mass-to-charge ratio range. Based on the detection signal obtained in the ion detector 10 during such mass scanning, a mass spectrum can be generated in an unillustrated data processing unit.

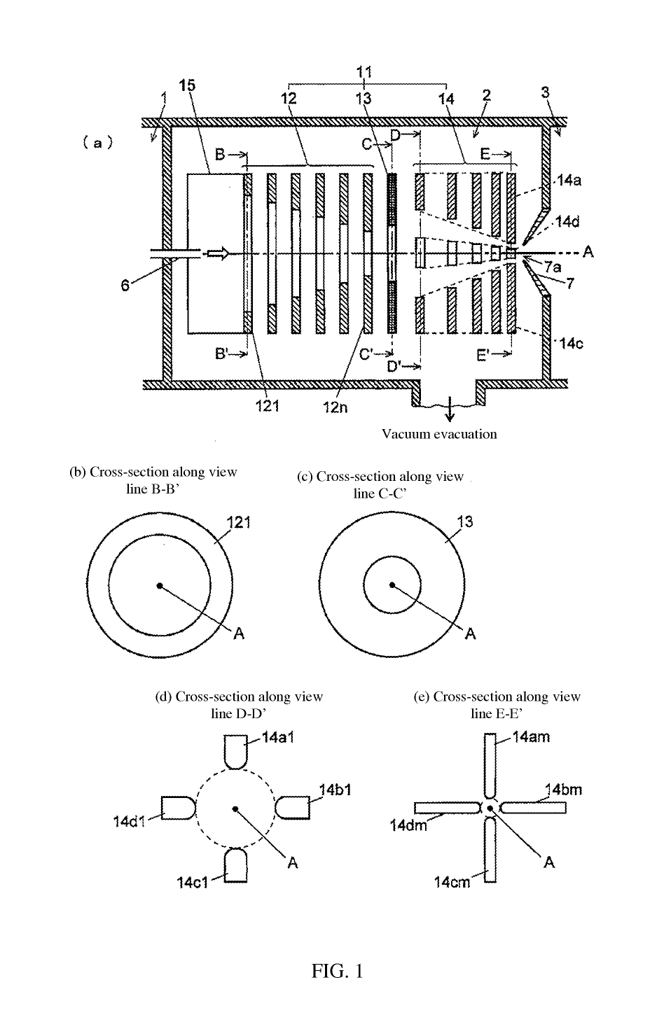

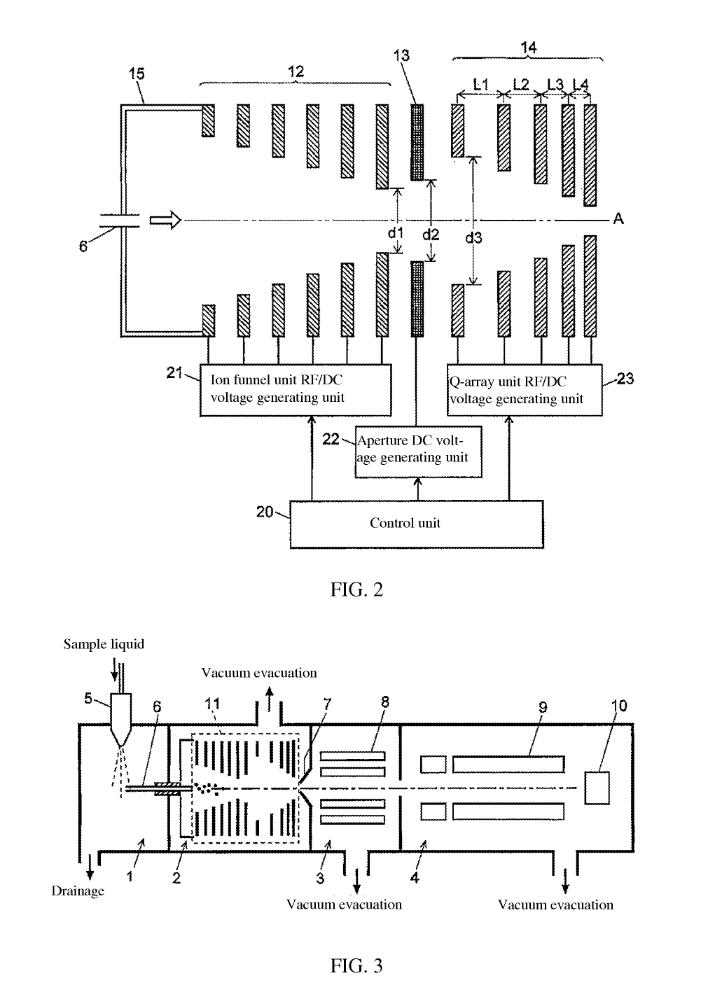

The ion guide 11 arranged in the first intermediate vacuum chamber 2 in this atmospheric pressure ionization mass analysis device is an embodiment example of the ion transport device according to the present invention. This ion guide 11 will be described in detail with reference to FIG. 1 and FIG. 2.

FIG. 1 (a) is a schematic diagram centered on the electrode part of ion guide 11 inside the first intermediate vacuum chamber 2, and FIG. 1 (b) through (e) are a cross-sectional view along FIG. 1 (a) view line B-B′, a cross-sectional view along view line C-C′, a cross-sectional view along view line D-D′, and a cross-sectional view along view line E-E′. Furthermore, FIG. 2 is a diagram of the electrode part and electric circuit part of ion guide 11. In FIG. 1, the electrode part is shown in cross-section, and in FIG. 2, in order to make the region through which ions transit easier to understand, the electrode part is shown as an end face on a plane containing ion optical axis A.

The ion guide 11 comprises an inlet side first ion transport unit 12 which is entered by ions fed from the ionization chamber 1 through the desolventizing tube 6; an outlet side second ion transport unit 14 which outputs ions to the second intermediate vacuum chamber 3 through the orifice 7a; and an aperture electrode 13 which partitions the first ion transport unit 12 from the second ion transport unit 14.

The first ion transport unit 12 has similar structure to a conventional ion funnel, comprising multiple ring electrodes 121, . . . , 12n whereof the opening inside diameter becomes smaller in stepwise fashion in the ion transport direction. These multiple ring electrodes 121, . . . , 12n are arranged equidistantly so as to be orthogonal to the ion optical axis A. In the example of FIG. 1 and FIG. 2, the number n of ring electrodes is 6, but this number is an example and the invention is not limited thereto.

The second ion transport unit 14 has a similar structure to a conventional Q-array and comprises four virtual rod electrodes 14a, 14b, 14c and 14d, arranged so as to surround the ion optical axis A, and each virtual rod electrode 14a, 14b, 14c, 14d comprises multiple electrode plates (for example, 14a1, . . . , 14am) separated in the direction of ion optical axis A. The four virtual rod electrodes 14a through 14d contact the outer circumference of a circular cone centered on ion optical axis A with an inside diameter which becomes smaller in the ion travel direction, and are arranged so that the angular gap between two virtual rod electrodes adjacent in the circumferential direction is 90°. Furthermore, the gap between electrode plates adjacent in the direction of ion optical axis A becomes narrower in stepwise fashion in the ion travel direction. Moreover, as indicated in FIGS. 1 (d) and (e), etc., the electrode plates are formed so that the end which faces the ion optical axis A has a substantially circular arc shape, and the width of each electrode plate in the ion travel direction becomes narrower in a stepwise fashion. In this example, the number of electrode plates contained in each of the four virtual rod electrodes 14a, 14b, 14c, 14d is 5, but the number is not limited thereto.

The aperture electrode 13 is an electrode having a round central opening of similar shape to the ring electrodes of the first ion transport unit 12.

Here, the magnitude relationship of the inside diameter d1 of the central opening in the ring electrode 12n at the final stage of the first ion transport unit 12, the inside diameter d2 of the central opening in the aperture electrode 13, and the inside diameter d3 of the inscribed circle of the four electrode plates 14am through 14dm of the first stage of the second ion transport unit 14, is specified to be d3>d2>d1.

Each ring electrode 121, . . . , 12n of the first ion transport unit 12 is connected to an ion funnel unit RF/DC voltage generating unit 21, which applies a voltage comprising a superimposed high frequency voltage and direct current voltage to each ring electrode. Specifically, to any two ring electrodes adjacent in the direction of ion optical axis A, high frequency voltages of the same amplitude and frequency but with phases differing by 180° are applied. Furthermore, for example, the same direct current voltage is applied to all the ring electrodes, or a direct current voltage whereof the voltage level changes stepwise in the ion travel direction is applied. The voltage level of this direct current voltage can be set at one's discretion.

The electrode plates contained in each of the virtual rod electrodes 14a through 14d of the second ion transport unit 14 are connected to Q-array unit RF/DC voltage generating unit 23, which applies a voltage comprising a superimposed high frequency voltage and direct current voltage to each electrode plate. Specifically, the same high frequency voltage is applied to one virtual rod electrode 14a through 14d, the same high frequency voltage is applied to two virtual rod electrodes 14a/14c and 14b/14d opposing each other across the ion optical axis A, and high frequency voltages of the same amplitude and phase but with phases which differ by 180° are applied to two virtual rod electrodes 14a/14b and 14c/14d adjacent about the ion optical axis A. Furthermore, for example, the same direct current voltage is applied to all the ring electrodes, or a direct current voltage whereof the voltage level changes stepwise in the ion travel direction is applied. The voltage level of this direct current voltage can be set at one's discretion.

Furthermore, aperture DC voltage generating unit 22 is connected to the aperture electrode 13. The aperture DC voltage generating unit 22 applies a predetermined direct current voltage to the aperture electrode 13. These voltage generating units 21 through 23 operate based on control signals from control unit 20.

Here, before describing the operation of the ion guide 11 having a configuration as described above, the characteristics of existing ion funnels, multipole ion guides and Q-arrays will be described in comparison to each other.

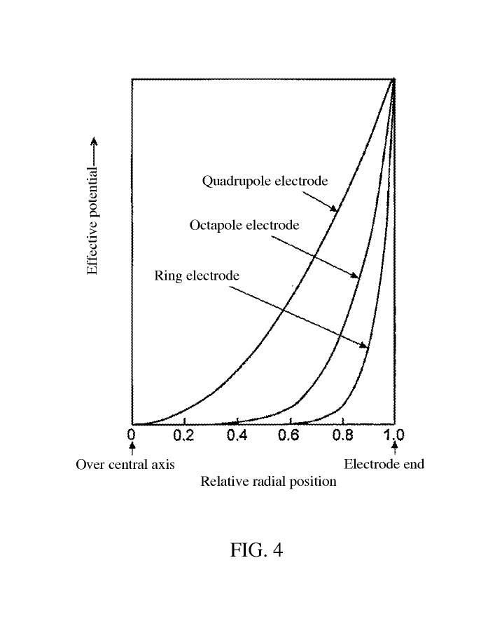

FIG. 4 is the computation results for the pseudopotential distribution of an ion transport optical system comprising ring electrodes (i.e. an ion funnel) and an ion transport optical system using a multipole (quadrupole, octapole) ion guide. The horizontal axis in this graph is the relative radial position and the vertical axis is the effective pseudopotential intensity.

As can be seen from FIG. 4, the radial pseudopotential distribution in an ion funnel presents a well-like shape wherein the potential rapidly becomes deep when approaching the central axis from the electrode in the region near the ring electrodes (of a size approximately equal to the gap between adjacent ring electrodes). Thus, the potential gradient in the vicinity of the ring electrodes is high and the force acting so as to return ions toward the central axis is large. Ions which have been pushed back toward the central axis, in conjunction with the collisional cooling effect, are distributed at the wide bottom of the convex part of the pseudopotential. By contrast, in the radial pseudopotential distribution in a multipole ion guide, the gradient of the potential which becomes deeper as one approaches the central axis from the rod electrode is clearly gentler as compared to an ion funnel, and the force pushing ions back toward the central axis in the vicinity of the ring electrodes is weaker. Moreover, the width of the bottom of the concave part of the pseudopotential is relatively narrow, and the spatial distribution of ions focused by the effect of collisional cooling is small.

In this way, an ion funnel has a high ion acceptance due to the wide bottom of the concave part of the pseudopotential, and is able to efficiently capture ions arriving in a radially spatially spread state. Furthermore, since an ion funnel employs ring electrodes, the force which pushes ions toward the central axis acts across the entire circumference, which also contributes to increasing the acceptance as compared to a multipole ion guide.

On the other hand, compared to a multipole ion guide, an ion funnel has a relative large width of the concave part of the pseudopotential at the outlet, and thus has high ion emittance. Consequently, it is disadvantageous for efficiently sending ions into a small diameter orifice. In order to improve (i.e. reduce) ion emittance in an ion funnel, it is necessary to reduce the inside diameter of the opening of the ring electrodes on the outlet side, but if this is done, the low-mass cut off phenomenon, whereby the transmittance with respect to low mass ions decreases, will become a problem. Specifically, if the inside diameter of the opening of the outlet ring electrode of an ion funnel is reduced to about the same as the gap between adjacent ring electrodes in the ion transport direction, the high frequency electric field will start to influence ions transiting in the vicinity of the ion optical axis. Ions of smaller mass-to-charge ratio are more susceptible to this influence, whereby the amplitude of the ion trajectory become larger and the ions become prone to colliding with the ring electrodes and disappearing. As a result, ions of low mass-to-charge ratio become unable to pass through the ion funnel.

By contrast, the width of the bottom of the concave part of the pseudopotential of a multipole ion guide is narrow compared to an ion funnel. In particular, a quadrupole ion guide has a small width of the bottom of the concave part of the pseudopotential, providing a strong spatial focusing effect and having low ion emittance at the outlet. Namely, comparing an ion funnel to a multipole ion guide, an ion funnel is superior in terms of ion acceptance characteristic but inferior in terms of ion emittance characteristic, while a multipole ion guide is superior in terms of ion emittance characteristic but inferior in terms of ion acceptance characteristic. The pseudopotential distribution of a Q-array is basically about the same as that of a quadrupole ion guide, so the ion acceptance characteristic and ion emittance characteristic are about the same as with a quadrupole ion guide.

However, with a Q-array, it is possible to adjust the acceptance characteristic and emittance characteristic by adjusting the inscribed circle diameter of the electrode plates and the gap between the electrode plates. Specifically, if the distance between the electrode plates making up the virtual rod electrode is made smaller, the quadrupole electric field will become dominant, and conversely, if the gap between electrode plates is increased, the ratio of higher order multipole components will become relatively larger. Thus, if the gap between electrode plates on the inlet side is increased, the acceptance due to the effect of high order multipole field components will become greater. On the other hand, if the gap between electrode plates on the outlet side is reduced, the quadrupole electric field component will become stronger and emittance can be reduced. In addition to the gap between electrode plates, the width of the bottom of the pseudopotential can be controlled by adjusting the inscribed circle radius of the electrode plates, allowing one to achieve further expansion of acceptance and reduction of emittance as compared to a multipole ion guide.

Furthermore, if one considers the optimal gas pressure for ion transport operation, as described above, an ion funnel has a radial pseudopotential distribution which is well-shaped, so the frequency of collisions between the ions and the gas is high, making an ion funnel suitable for ion transport in a low vacuum atmosphere. On the other hand, an ion funnel has low gas conductance between the region through which ions transit and the outside region, and is thus prone to having low degree of vacuum at the outlet side. By contrast, a Q-array has gaps both between circumferentially adjacent electrode plates and adjacent electrode plates in the ion axis direction, so the gas conductance between the region through which ions transit and the outside region is higher as compared to an ion funnel or multipole ion guide.

To make use of an ion funnel's greater ion acceptance and the higher ion confinement capability under relatively high gas pressure conditions, as described above, in the ion guide 11 of the present embodiment example, a first ion transport unit 12 with an ion funnel structure is arranged in the front half unit. Furthermore, in order to make use of the smaller ion emittance and greater gas conductance of a Q-array, as described above, in the ion guide 11 of the present embodiment example, a second ion transport unit 14 with a Q-array structure is arranged in the rear half unit. Furthermore, while the potential distribution of the high frequency electric fields formed in the space surrounded by the electrodes (i.e. the region through which ions transit) differs between the first ion transport unit 12 and the second ion transport unit 14, by providing between them an aperture electrode 13 to which only direct current voltage is applied, mutual interference of those high frequency electric fields is reduced.

Furthermore, the inside diameter of the opening of the first stage ring electrode 121 of the first ion transport unit 12 is made sufficiently large to provide adequate acceptance with respect to the spatial distribution of ions introduced through the desolventizing tube 6. Moreover, the inscribed circle diameter of the last stage electrode plates 14am through 14dm of the second ion transport unit 14 which feeds ions into the orifice 7a is made sufficiently small to achieve low emittance that would allow adequately high transmittance with regard to the orifice 7a.

Ions which are forcefully introduced into the first intermediate vacuum chamber 2 through the desolventizing tube 6 along with gas (ambient air) move forward while spreading significantly due to adiabatic expansion at the outlet of the desolventizing tube 6. By contrast, the ion acceptance of the ion guide 11 is large, as described above, and the confinement force on ions based on the pseudopotential distribution is strong, making it possible to capture, at low loss, even ions located at the periphery of the ion flow which spreads as it moves forward. Moreover, with the ion guide 11 of the present embodiment example, a cover 15 is provided, which surrounds the space at the front of the first stage ring electrode 121 and at the outer circumference of the desolventizing tube 6 so that the pressure inside the central opening of the ion funnel structure increases appropriately. Due to this cover 15, the gas conductance to the front of the first stage ring electrode 121 also becomes lower. As a result, it becomes possible to efficiently collect ions which have been collisionally cooled under high gas pressure in the central opening of the first ion transport unit 12 and which have been discharged from the desolventizing tube 6 with a high energy.

The inside diameter of the central opening of the ring electrodes 121 through 12n of the first ion transport unit 12 gradually becomes narrower in the ion travel direction, so ions confined in the pseudopotential distribution due to the high frequency electric field are reduced into a narrower range as they travel forward. The diameter of the central opening of the aperture electrode 13 is greater than the inside diameter of the central opening of the last stage ring electrode 12n of the first ion transport unit 12, while the radius of the inscribed circle of the first stage electrode plates 14a1 through 14d1 of the second ion transport unit 14 is greater than the diameter of the central opening of the aperture electrode 13. Thus, ions which have been focused to an extent in the first ion transport unit 12 pass through the central opening of the aperture electrode 13 at low loss, and are efficiently introduced into the concave part of the pseudo energy distribution formed in the inner space of the second ion transport unit 14. Here, the gap between the electrode plates 14a1 through 14d1, . . . , 14am through 14dm of the second ion transport unit 14 is wider on the inlet side, so the acceptance becomes greater as compared to when that gap is narrow. Furthermore, interference between the high frequency electric fields of the first ion transport unit 12 and the second ion transport unit 14 is prevented by the high frequency electric field shielding effect of the aperture electrode 13, thereby preventing the spatial spread of the ion beam entering the second ion transport unit 14 from the first ion transport unit 12 due to disturbances in the electric field. As a result, ions which have exited the first ion transport unit 12 are efficiently introduced into the second ion transport unit 14. Furthermore, ions are focused as they travel through the second ion transport unit 14, and since the gap between the electrode plates 14a1 through 14d1, . . . , 14am through 14dm is narrow especially on the outlet side, the focusing effect of the quadrupole component of the high frequency electric field is strengthened, and the ions are outputted from the second ion transport unit 14 with an adequately low emittance. As a result, ions can be made to transit through the first intermediate vacuum chamber 2 and fed into the second intermediate vacuum chamber 3 with a high efficiency.

Furthermore, gas which has been discharged from the desolventizing tube 6 does not disperse to the front to the first ion transport unit 12 because of the cover 15, so much of the gas travels in the same direction as the ions, but the gaps between circumferentially adjacent electrode plates is larger in the second ion transport unit 14, so the gas disperses rapidly to the periphery through those gaps and is evacuated by the vacuum pump. As a result, the gas pressure near the orifice 7a at the vertex of the skimmer 7 is about as low as in the surrounding area, making it possible to avoid the flow of large amounts of gas into the second intermediate vacuum chamber 3 through the orifice 7a.

It should be noted that the embodiment example described above is just one example of the present invention, and any modifications, corrections or additions made within the gist of the present invention are of course also included within the scope of patent claims of the present application.

### DESCRIPTION OF REFERENCE SYMBOLS

1 . . . Ionization chamber
2 . . . First intermediate vacuum chamber
3 . . . Second intermediate vacuum chamber
4 . . . Analysis chamber
5 . . . ESI probe
6 . . . Desolventizing tube
7 . . . Skimmer
7a . . . Orifice
8 . . . Octapole ion guide
9 . . . Quadrupole mass filter
10 . . . Ion detector
11 . . . Ion guide
12 . . . First ion transport unit
121-12n . . . Ring electrode
13 . . . Aperture electrode
14 . . . Second ion transport unit
14a-14d . . . Virtual rod electrode
14a1-14am, 14b1-14bm, 14c1-14 cm, 14d1-14dm . . . Electrode plate
20 . . . Control unit
21 . . . Ion funnel unit RF/DC voltage generating unit
22 . . . Aperture DC voltage generating unit
23 . . . Q-array unit RF/DC voltage generating unit
A . . . Ion optical axis

What is claimed:

1. An ion transport device which is arranged, for the purpose of transporting ions from a first region with a relatively high gas pressure atmosphere to a second region with a relatively low gas pressure atmosphere, in a third region with an atmosphere with gas pressure between that of those two regions, the ion transport device comprising:
a) a first ion transport unit which is arranged on the inlet side from which ions fed from said first region enter, the first ion transport unit comprising multiple ring electrodes arrayed along the ion optical axis and a funnel structure wherein the inside diameter of the opening of the ring electrodes on the inlet side is greater than the inside diameter of the opening of the ring electrodes on the outlet side;
b) a second ion transport unit which is arranged after said first ion transport unit, and wherein an even number of four or more virtual rod electrodes, the second ion transport unit comprising a plurality of electrode plates arrayed along the ion optical axis, are arranged about the ion optical axis, and the inscribed circle of the electrode plates contained within each of the virtual rod electrodes within the plane orthogonal to the ion optical axis decreases gradually from the inlet side to the outlet side;
c) an aperture electrode which is arranged between said first ion transport unit and said second ion transport unit and has an opening in the center through which ions transit; and
d) a voltage generator configured to apply a voltage comprising a superimposed high frequency voltage and direct current voltage to the ring electrodes contained in said first ion transport unit and to the electrode plates contained in said second ion transport unit, and to apply a direct current voltage to said aperture electrode.

2. An ion transport device which is arranged, for the purpose of transporting ions from a first region with a relatively high gas pressure atmosphere to a second region with a relatively low gas pressure atmosphere, in a third region with an atmosphere with gas pressure between that of those two regions, the ion transport device comprising:
a) a first ion transport unit which is arranged on the inlet side from which ions fed from said first region enter, the first ion transport unit comprising multiple ring electrodes arrayed along the ion optical axis and a funnel structure wherein the inside diameter of the opening of the ring electrodes on the inlet side is greater than the inside diameter of the opening of the ring electrodes on the outlet side;
b) a second ion transport unit which is arranged after said first ion transport unit, and wherein an even number of four or more virtual rod electrodes, the second ion transport unit comprising a plurality of electrode plates arrayed along the ion optical axis, are arranged about the ion optical axis, and the gap between adjacent electrode plates in the ion optical axis direction in each of the virtual rod electrodes decreases gradually from the inlet side to the outlet side;
c) an aperture electrode which is arranged between said first ion transport unit and said second ion transport unit and has an opening in the center through which ions transit; and
d) a voltage generator configured to apply a voltage comprising a superimposed high frequency voltage and direct current voltage to the ring electrodes contained in said first ion transport unit and to the electrode plates contained in said second ion transport unit, and to apply a direct current voltage to said aperture electrode.

3. An ion transport device as described in claim 1, characterized in that the inside diameter of said aperture electrode is made greater than the inside diameter of the opening of the last stage ring electrode of said first ion transport unit and smaller that the inscribed circle diameter of the first stage electrode plates of said second ion transport unit.

4. An ion transport device as described in claim 1, characterized in that a barrier structure, for reducing gas conductance between the space of the opening of the ring electrodes in said first ion transport unit and the space on the outside of said first ion transport unit, is provided in front of said first ion transport unit.

5. A mass analysis device using an ion transport unit as described in claim 1, characterized in that it comprises an ionization unit which ionizes a sample under an ambient pressure atmosphere; an analysis chamber which is maintained at a high vacuum atmosphere and in which a mass separation unit is provided; and one or multiple intermediate vacuum chambers which are arranged between said ionization unit and said analysis chamber, and wherein the degree of vacuum increases in stepwise fashion; wherein said ion transport device is installed within the intermediate vacuum chamber at the next stage after said ionization unit.

6. An ion transport device as described in claim 2, characterized in that the inside diameter of said aperture electrode is made greater than the inside diameter of the opening of the last stage ring electrode of said first ion transport unit and smaller that the inscribed circle diameter of the first stage electrode plates of said second ion transport unit.

7. An ion transport device as described in claim 2, characterized in that a barrier structure, for reducing gas conductance between the space of the opening of the ring electrodes in said first ion transport unit and the space on the outside of said first ion transport unit, is provided in front of said first ion transport unit.

8. A mass analysis device using an ion transport unit as described in claim 2, characterized in that it comprises an ionization unit which ionizes a sample under an ambient pressure atmosphere; an analysis chamber which is maintained at a high vacuum atmosphere and in which a mass separation unit is provided; and one or multiple intermediate vacuum chambers which are arranged between said ionization unit and said analysis chamber, and wherein the degree of vacuum increases in stepwise fashion; wherein said ion transport device is installed within the intermediate vacuum chamber at the next stage after said ionization unit.
